(19) United States
(12) Patent Application Publication
(10) Pub. No.: US 2008/0287089 A1
(43) Pub. Date: Nov. 20, 2008

(54) INPUT FILTER FOR IMAGE FREQUENCY SUPPRESSION

(76) Inventor: Martin Alles, Obersulm-Willsbach (DE)

Correspondence Address: Muncy, Geissler, Olds & Lowe, PLLC, P.O. BOX 1364, FAIRFAX, VA, 22038-1364, US

(21) Appl. No.: 12/123,538

(22) Filed: May 20, 2008

Related U.S. Application Data
(63) Continuation of application No. PCT/EP2006/010831, filed on Nov. 11, 2006.

(30) Foreign Application Priority Data
Nov. 20, 2005 (DE) DE 102005056486.0

(51) Int. Cl. H04B 1/16

(52) U.S. Cl. 455/339

(57) ABSTRACT

An input filter is provided for a superheterodyne receiver for image frequency suppression and a method for operating a superheterodyne receiver. The input filter for a superheterodyne receiver includes a first filter circuit with bandpass characteristics and a center frequency that can be preset as a function of a desired receive frequency, the circuit having a varactor diode and a first filter inductor that are connected in parallel and form a parallel-resonant circuit, wherein the center frequency can be preset by application of a control voltage to the varactor diode, and a second filter circuit with band stop characteristics that includes the varactor diode and a second filter inductor, these being connected in series and forming a series-resonant circuit, and that has a maximum attenuation in the vicinity of an image frequency belonging to the desired receive frequency. The input filter may be used in, for example, DAB receivers.

This nonprovisional application is a continuation of International Application No. PCT/EP2006/010831, which was filed on Nov. 11, 2006, and which claims priority to German Patent Application No. 10 2005 056 486.0, which was filed in Germany on Nov. 20, 2005, and which are both herein incorporated by reference.

### BACKGROUND OF THE INVENTION

1. Field of the Invention

The invention relates to an input filter for a superheterodyne receiver for image frequency suppression and a method for operating a superheterodyne receiver.

2. Description of the Background Art

Superheterodyne receivers (also known as heterodyne receivers) are used to receive high-frequency signals transmitted wirelessly. Such receivers are used in radio receivers and cell phones, for example. In contrast to what are known as direct-detection receivers, the received signal in a superheterodyne receiver is “mixed” or converted to one or more intermediate frequencies with the aid of something known as a mixer prior to demodulation.

To this end, the received signal is typically multiplied in the mixer by a sinusoidal oscillation signal with an adjustable tuning frequency that depends on the desired receive frequency. If the frequency of the received signal is fₑ, and the frequency of the oscillation signal or tuning frequency is fₒ, a mixer output signal has frequencies of fₒ+fₑ and fₒ−fₑ.

The mixer output signal is filtered by a so-called intermediate frequency filter. The intermediate frequency filter is typically designed as a bandpass filter, which is to say that a frequency band of the mixer output signal in the vicinity of the intermediate frequency f_{z} of the intermediate frequency filter is transmitted through the intermediate frequency filter essentially without attenuation. Spectral components of the mixer output signal outside the frequency band are sharply attenuated, or in the ideal case are not transmitted through the intermediate frequency filter.

Consequently, only received signals whose frequency satisfies fₑ=fₒ+f_{z} or fₑ=fₒ−f_{z} are transmitted through the intermediate frequency filter. In other words, only the received signals that are offset from the tuning frequency fₒ by the value of the intermediate frequency f_{z} are transmitted through the intermediate frequency filter.

The intermediate frequency f_{z} of the intermediate frequency filter is predefined statically here, thus making it possible to improve the filter characteristics of the intermediate frequency filter in comparison to a case in which the frequency is set dynamically as a function of the desired receive frequency, since the filter characteristics remain constant over the entire receive frequency range.

When the input signal of the receiver is provided unfiltered to the mixer, input signals with frequencies fₑ=fₒ+f_{z} and fₑ=fₒ−f_{z} are superimposed in the mixer output signal, with the unwanted result that two radio transmitters can be received at the same time, for example, if transmission is taking place on both frequencies. For example, if only the frequency fₑ=fₒ−f_{z} is supposed to appear at the output of the mixer, the input signal has to be filtered by an input filter, for example having a bandpass characteristic, in such a manner that the desired frequency fₑ=fₒ−f_{z} is attenuated as little as possible and the frequency fₑ=fₒ+f_{z} is attenuated as much as possible. The frequency that is to be suppressed, here fₑ=fₒ+f_{z}, is called the image frequency.

Alternatively, if only the frequency fₑ=fₒ+f_{z} is supposed to appear at the output of the mixer, the input filter must be dimensioned accordingly to suppress the frequency fₑ=fₒ−f_{z}. The image frequency in this case is fₑ=fₒ−f_{z}.

Since the image frequency changes as a function of the variable, desired receive frequency, so-called tracking input filters are known for image frequency suppression that change their filter characteristics, for example their center frequencies, as a function of the set or desired receive frequency. In this way, the filter properties can be improved as compared with statically dimensioned filters.

### SUMMARY OF THE INVENTION

It is therefore an object of the invention is to make available an input filter for a superheterodyne receiver and a method for operating a superheterodyne receiver which attenuate the desired receive frequency as little as possible and attenuate the image frequency as much as possible.

The inventive input filter according to an embodiment includes a first filter circuit with bandpass characteristics and a center frequency that can be preset as a function of the desired receive frequency, said circuit having a varactor diode and a first filter inductor that are connected in parallel and form a parallel-resonant circuit, wherein the center frequency can be preset by application of a control voltage to the varactor diode. The input filter further contains a second filter circuit with band stop characteristics that includes the varactor diode and a second filter inductor. The varactor diode and the second filter inductor are connected in series and form a series-resonant circuit. The second filter circuit has a maximum attenuation in the vicinity of an image frequency belonging to the desired receive frequency. The second filter circuit is dimensioned such that its impedance has the smallest possible values in the vicinity of the image frequency. This achieves a selective additional attenuation of the image frequency without causing an additional attenuation of the desired receive frequency. When the receive frequency is changed by applying the control voltage to the varactor diode, both the center frequency of the parallel-resonant circuit and the frequency range of maximum attenuation of the series-resonant circuit change, since the tuning diode or varactor diode is part of both the parallel-resonant circuit and the series-resonant circuit. In this way, automatic tracking of the image frequency suppression is achieved without additional control intervention when the receive frequency is changed.

In a further embodiment of the input filter, the second filter inductor is connected between a connecting node of a first terminal of the varactor diode and a first terminal of the first filter inductor and a ground potential. This achieves an optimal coupling of the two filter circuits.

In a further embodiment of the input filter, a first DC decoupling capacitor is provided and is connected between the connecting node of the first terminal of the varactor diode and the first terminal of the first filter inductor and the second filter inductor. In this way the control voltage applied to the varactor diode is DC isolated or separated from the second filter inductor.

In a further embodiment of the input filter, a second DC decoupling capacitor is provided, which is connected between a second terminal of the varactor diode and a second terminal of the first filter inductor. This prevents the control voltage applied to the varactor diode from being short-circuited by the first filter inductor.

In a further embodiment of the input filter, a reference voltage connection resistor is provided, which is connected between the second terminal of the varactor diode and a ground potential. This reference voltage connection resistor serves to connect the second terminal, for example the anode, of the varactor diode to the reference voltage in order to establish a voltage difference across the varactor diode in conjunction with the control voltage applied to the first terminal of the varactor diode, determining the effective capacitance. High frequencies are not transmitted through the reference voltage connection resistor, which in particular is a high resistance, on account of the mismatch.

In a further embodiment of the input filter, a third DC decoupling capacitor is provided, which is connected between a second terminal of the varactor diode and an input terminal of the input filter. This is used for DC-decoupling of the input terminal.

In a further embodiment of the input filter, a control voltage connection resistor is provided, which is connected between a connecting node of a first terminal of the varactor diode and a first terminal of the first filter inductor and a control voltage source. This is used for HF-decoupling of the control voltage source.

In a further embodiment of the input filter, a fourth DC decoupling capacitor is provided, which is connected between a second terminal of the first filter inductor and an output terminal of the input filter. This is used for DC-decoupling of the output terminal.

In the inventive method for operating a superheterodyne receiver, an input signal of the superheterodyne receiver is filtered with a bandpass characteristic, wherein a center frequency of the bandpass characteristic can be preset as a function of a desired receive frequency. The input signal is further filtered with a band stop characteristic whose maximum attenuation lies in the vicinity of an image frequency belonging to the desired receive frequency. This achieves a significant improvement in the attenuation of the image frequency without the occurrence of undesired attenuation losses in the receive frequency.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a superheterodyne receiver in the form of a DAB receiver having an inventive input filter, and

FIG. 2 illustrates a transfer function of the input filter from FIG. 1.

### DETAILED DESCRIPTION

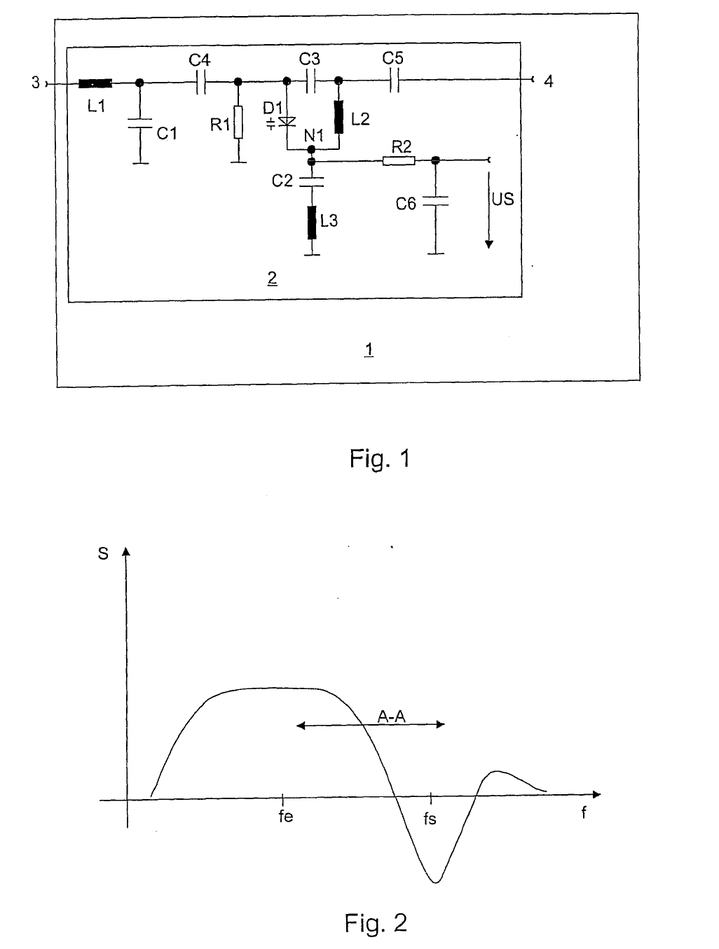

FIG. 1 shows a superheterodyne receiver in the form of a DAB receiver 1 with an inventive input filter 2.

The input filter 2 includes an input terminal 3 for connecting to an antenna that is not shown, an output terminal 4 to output a filtered input signal, a low-pass input filter in the form of an inductor or coil L1 and a capacitor C1, a first filter circuit in the form of a parallel-resonant circuit of a varactor diode D1 and a filter inductor L2, a second filter circuit in the form of a series-resonant circuit of the varactor diode D1 and a second filter inductor L3, a first DC decoupling capacitor C2 that is connected between the connecting node N1 of a first terminal of the varactor diode D1 and a first terminal of the first filter inductor L2 and the second filter inductor L3, a second DC decoupling capacitor C3 that is connected between a second terminal of the varactor diode D1 and a second terminal of the first filter inductor L2, a third DC decoupling capacitor C4 that is connected between the second terminal of the varactor diode and an input terminal 3 of the input filter 2, a fourth DC decoupling capacitor C5 that is connected between the second terminal of the first filter inductor L2 and the output terminal 4 of the input filter 2, a reference voltage connection resistor R1 that is connected between the second terminal of the varactor diode D1 and a ground or grounding potential, a control voltage connection resistor R2 that is connected between the connecting node N1 of the first terminal of the varactor diode D1 and the first terminal of the first filter inductor L2 and a control voltage source US, and a filter capacitor C6.

The input filter 2 is used for image frequency suppression of a receive signal present at the input terminal 3 and is designed as a tracking filter, which is to say that its filter characteristic, for example its center frequency and a region with maximum attenuation, is selected as a function of the desired receive frequency. Connected to the output terminal 4 is an amplifier that is not shown, followed by a mixer to convert the filtered signal at the output terminal 4 to a mixer frequency. These units largely correspond to those in a conventional DAB receiver and are thus not described in detail.

The DC decoupling capacitor C4 serves to DC-decouple the input 3, and the DC decoupling capacitor C5 serves to DC-decouple the output 5. The DC decoupling capacitor C3 prevents the control voltage US from being DC short-circuited to ground through the first filter inductor L2 and the reference voltage connection resistor R1. For high frequencies, the DC decoupling capacitor C3 acts as a short circuit. The DC decoupling capacitor C2 prevents the control voltage US from being DC short-circuited to ground through the second filter inductor L3. For high frequencies, the DC decoupling capacitor C2 acts as a short circuit.

The control voltage US present at the varactor diode D1 determines its effective capacitance. The control voltage US is selected or generated such that the parallel-resonant circuit constitutes an open circuit for a desired receive frequency fₑ.

The reference voltage connection resistor R1 provides a DC connection between the anode of the varactor diode D1 and ground, and constitutes an open circuit for high frequencies on account of a mismatch. The control voltage connection resistor R2 provides a DC connection between the cathode of the varactor diode D1 and the control voltage US, and constitutes an open circuit for high frequencies on account of a mismatch, which is to say that it HF-decouples the control voltage US from the remaining circuit components. The capacitor C6 serves as a filter.

The low-pass input filter consisting of the inductor L1 and the capacitor C1 serves to isolate or suppress what is known as an L band in the frequency range from approximately 1452 MHz to 1492 MHz. The transfer function of the low-pass input filter is dimensioned such that input signals in what is called a VHF Bill band in the frequency range from approximately 174 MHz to 240 MHz are passed through.

The first filter circuit consisting of the varactor diode D1 and the first filter inductor L2 has a bandpass characteristic, wherein a center frequency of the bandpass can be preset by application of the control voltage US to the varactor diode D1, and the control voltage US is established as a function of a desired receive frequency fe.

The second filter circuit consisting of the varactor diode D1 and the second filter inductor L3 has a band stop characteristic with a maximum attenuation in the vicinity of an image frequency fₛ belonging to the desired receive frequency fₑ. The value of the image frequency fₛ results from the selected receive frequency fₑ or a tuning frequency of a conventional mixer that is not shown, and a selected intermediate frequency f_{z} of the superheterodyne receiver 1.

FIG. 2 shows a transfer function of the input filter 2 from FIG. 1. As a result of the combination of the bandpass characteristic of the parallel-resonant circuit consisting of the varactor diode D1 and the first filter inductor L2 and the band stop characteristic of the series-resonant circuit consisting of the varactor diode D1 and the second filter inductor L3, the input signal can pass through the input filter 2 in the frequency range of the established or preset receive frequency fₑ essentially unattenuated, while in contrast a high attenuation occurs at the image frequency fₛ.

Since the varactor diode D1 is part of both resonant circuits, a change in the capacitance of the varactor diode D1 results in both a displacement of the center frequency of the parallel-resonant circuit and a displacement of the frequency of maximum attenuation of the series-resonant circuit. Consequently, the transfer function shown in FIG. 2 is displaced approximately along the axis A-A in the Y direction as a function of the selected control voltage US.

The embodiment of the input filter 2 that is shown has a filter characteristic wherein the desired receive frequency fₑ is attenuated only slightly or not at all and the image frequency fₛ is strongly attenuated. As a result of the selective increase of the image frequency attenuation by the second filter circuit that arises from the insertion of the second filter inductor L3 between the base point N1 of the parallel-resonant circuit and ground, the input filter can be designed with reduced selectivity. Overall, this results in improved receive performance of the receiver 1.

In the embodiment shown, the input filter 2 is used in the DAB receiver 1. It is a matter of course that the input filter 2 can also be used in other receivers, for example DVB receivers or conventional AM/FM radio receivers.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An input filter for a superheterodyne receiver comprising:
a first filter circuit having bandpass characteristics and a center frequency that is preset as a function of a desired receive frequency, the first filter circuit having a varactor diode and a first filter inductor that are connected in parallel and form a parallel-resonant circuit, wherein the center frequency is preset by application of a control voltage to the varactor diode; and
a second filter circuit having band stop characteristics that includes the varactor diode and a second filter inductor being connected in series and forming a series-resonant circuit, and that has a maximum attenuation in the vicinity of an image frequency belonging to the desired receive frequency.

2. The input filter according to claim 1, wherein the second filter inductor is connected between a connecting node of a first terminal of the varactor diode and a first terminal of the first filter inductor and a ground potential.

3. The input filter according to claim 2, further comprising a first DC decoupling capacitor, which is connected between the connecting node of the first terminal of the varactor diode and the first terminal of the first filter inductor and the second filter inductor.

4. The input filter according to claim 1, further comprising a second DC decoupling capacitor, which is connected between a second terminal of the varactor diode and a second terminal of the first filter inductor.

5. The input filter according to claim 1, further comprising a reference voltage connection resistor, which is connected between the second terminal of the varactor diode and a ground potential.

6. The input filter according to claim 1, further comprising a third DC decoupling capacitor, which is connected between a second terminal of the varactor diode and an input terminal of the input filter.

7. The input filter according to claim 1, further comprising a control voltage connection resistor, which is connected between a connecting node of a first terminal of the varactor diode and a first terminal of the first filter inductor and a control voltage source.

8. The input filter according to claim 1, further comprising a fourth DC decoupling capacitor, which is connected between a second terminal of the first filter inductor and an output terminal of the input filter.

9. A method for operating a superheterodyne receiver, in which an input signal of the superheterodyne receiver is filtered with a bandpass characteristic, the method comprising:
presetting a center frequency of the bandpass characteristic as a function of a desired receive frequency; and
filtering the input signal with a band stop characteristic whose maximum attenuation lies in a vicinity of an image frequency belonging to the desired receive frequency.
